(19) United States
(12) Patent Application Publication
(10) Pub. No.: US 2013/0025381 A1
(43) Pub. Date: Jan. 31, 2013

(54) TESTING SYSTEM AND METHOD USING SAME

(71) Applicants: WEN-DONG LUO, Shenzhen City (CN); WEN-WU WANG, Shenzhen City (CN); TSUNG-JEN CHUANG, Tu-Cheng (TW); SHIH-FANG WONG, Tu-Cheng (TW); BIN LIU, Shenzhen City (CN)

(72) Inventors: WEN-DONG LUO, Shenzhen City (CN); WEN-WU WANG, Shenzhen City (CN); TSUNG-JEN CHUANG, Tu-Cheng (TW); SHIH-FANG WONG, Tu-Cheng (TW); BIN LIU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/339,380

(22) Filed: Dec. 29, 2011

(30) Foreign Application Priority Data
Jul. 29, 2011 (CN) 201110215679.2

(51) Int. Cl. G01N 17/00

(52) U.S. Cl. 73/865.6

(57) ABSTRACT

An electronic device is positioned in an environment regulating device controlling the environmental regulating device, and is tested under different test environments of the environment regulating device. The electronic device stores a number of standard environment values corresponding to the test environments. The environment regulating device regulates the testing environments according to the standard environment values. The electronic device tests itself in the different test environments.

### TECHNICAL FIELD

The disclosure generally relates to test technologies, and particularly, to a testing system and method.

### DESCRIPTION OF RELATED ART

An electronic device needs to be tested before leaving a manufacturing facility. In order to test performance of the electronic device in different environments, the electronic device is usually tested in different stable environments. However, every time the test environment needs to be changed, a worker has to manually adjust the environment, which is not convenient and results in low efficiency.

Therefore, it is desirable to provide a testing system and method which can overcome the above-mentioned problems.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a testing system.

FIG. 2 is a flowchart of one embodiment of a testing method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable median include CDs, DVDs, BLU-RAY, flash memory, and hard disk drives.

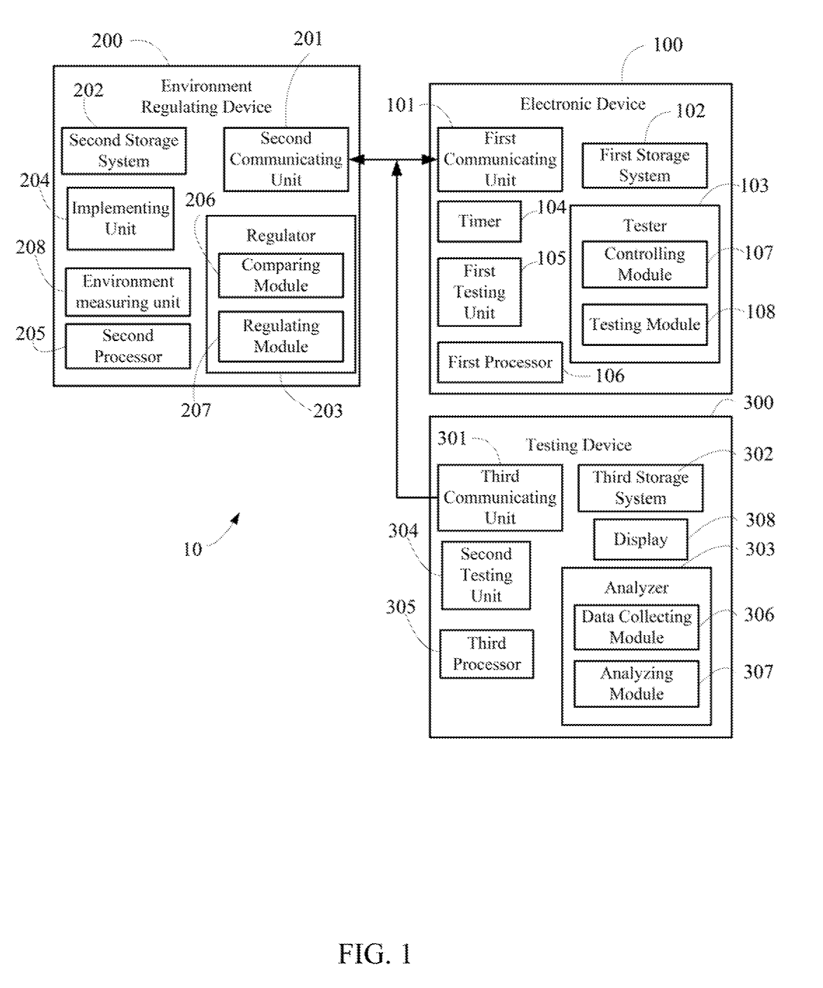

FIG. 1 is a block diagram of one embodiment of a testing system 10. In one embodiment, the testing system 10 may include an electronic device 100, an environment regulating device 200, and a testing device 300. The environment regulating device 200 provides different test environments in order to test the electronic device 100 under the different environments (different conditions). The environment regulating device 200 may be a thermotank. The electronic device 100 controls the environment regulating device 200 to change the test environment. The electronic device 100 connects to the environment regulating device 200 and the testing device 300 via a network. The network may be, but is not limited to, a wide area network such as the Internet, or a local area network, or a wireless network. The testing device 300 is configured for testing the electronic device 100, collecting a number of test results of the electronic device 100, and analyzing the test results. The testing device 300 may be a personal computer (PC), a network server, or any other item of data-processing equipment. The electronic device 100 may be, but is not limited to, a mobile phone, a personal digital assistant (PDA), or a tablet personal computer.

In one embodiment, the electronic device 100 includes a tester 103, a timer 104, a first testing unit 105, a first communicating unit 101, a first storage system 102, and at least one first processor 106.

The first storage system 102 is configured for storing a quantity of test information. The test information includes the order of execution of different test stages, a number of standard environment values of each test stage, and the duration of each test stage. The standard environment values may include, but are not limited to, a temperature-testing value, a pressure-testing value, and a humidity-adjustable value. The test stages correspond to different time points of a test of the electronic device 100 positioned inside the environment regulating device 200.

The timer 104 (e.g., the clock generator) is configured for timing each test stage. In detail, the timer 104 starts timing when a ready instruction is received from the environment regulating device 200. The timer 104 generates a test stage change instruction when the duration of one of the test stages has expired. The timer 104 pauses after generating the test stage change instruction. The timer 104 generates a finish instruction when the last test stage is finished. The timer 104 stops timing after generating the finish instruction.

The first testing unit 105 is configured for testing a number of working conditions of the electronic device 100. The working conditions may include, but are not limited to, output power, working current, and working voltage.

The tester 103 includes a controlling module 107 and a testing module 108. The controlling module 107 is configured for controlling the environment regulating device 200 to provide the different test environments according to the standard environment values included in the test information. In detail, the controlling module 107 transmits the standard environment value(s) of the first test stage to the environment regulating device 200. The controlling module 107 transmits the standard environment value of the next test stage to the environment regulating device 200 when the test stage change instruction is received from the timer 104.

The testing module 108 controls the first testing unit 105 to test the working conditions of the electronic device 100 and the testing device 300 to test a number of surface conditions of the electronic device 100 during each test stage. In detail, the testing module 108 starts the first testing unit 105 and the testing device 300 when the ready instruction is received from the environment regulating device 200. The testing module 108 suspends the first testing unit 105 and the testing device 300 when the test stage change instruction is received from the timer 104. The testing module 108 stops the first testing unit 105 and the testing device 300 when the finish instruction is received from the timer 104.

In one embodiment, the environment regulating device 200 includes a container (not shown), a regulator 203, an environment measuring unit 208, an implementing unit 204, a second communicating unit 201, a second storage system 202, and at least one second processor 205.

The container provides a test space for testing the electronic device 100. The environment measuring unit 208 is configured for measuring a number of test environment values within the container. The environment measuring unit 208 may include, but is not limited to, a thermometer, a hygrometer, and a gas pressure gauge.

The implementing unit 204 is configured for regulating the environment in the container. The implementing unit 204 may include, but is not limited to, a heater, a cooler, a humidifier, a dehumidifier or desiccator, and a vacuum pump. The regulator 203 is configured for controlling the implementing unit 204 to regulate the environment within the container. The regulator 203 includes a comparing module 206 and a regulating module 207.

The comparing module 206 is configured for receiving the standard environment value(s) of the test information from the controlling module 107 and comparing the test environment value(s) of the test environment(s) within the container with the standard environment value(s).

The regulating module 207 is configured for controlling the implementing unit 204 to regulate the environments within the container according to the result(s) of the comparison from the comparing module 206. The regulating module 207 controls the implementing unit 204 to decrease one of the environment values of the test environment within the container when the corresponding test environment value is greater than a maximum value according to a range for the corresponding standard environment value included in the test information. The regulating module 207 controls the implementing unit 204 to increase one of environment values of the test environment within the container when the corresponding test environment value is below a minimum value according to a range for the corresponding standard environment value included in the test information. When each test environment value of the test environment(s) within the container falls within the allowable range of each corresponding standard environment value contained in the test information, the test environment is stable. Thus, the regulating module 207 turns off the implementing unit 204 and generates the ready instruction.

In one embodiment, the testing device 300 includes a second testing unit 304, an analyzer 303, a third communicating unit 301, a display 308, a third storage system 302, and at least one third processor 305. The second testing unit 304 is also configured for testing the surface conditions of the electronic device 100. The characteristic conditions of the surface of the electronic device 100 may include, but not be limited to, temperature, mechanical stress, and resistance. The second testing unit 304 may include, but is not limited to, a temperature sensor, a stress sensor, and an ammeter.

The analyzer 303 includes a data collecting module 306 and an analyzing module 307. The data collecting module 306 collects the data from the first testing unit 105 and the second testing unit 304 when a finish instruction is received from the timer 104. The analyzing module 307 analyzes the data from first testing unit 105 and the second testing unit 304 to generate a resulting analysis. The analysis may include a comparative analysis and a statistical analysis.

The display 308, such as a liquid crystal display (LCD) or an organic light emitting display (OLED), may display a graphical user interface with the testing device 300. The user can see the testing process and read the results of the test in various forms, such as charts, text, and figures, via the graphical user interface. In one embodiment, the display 308 is a touch panel. Manipulation and input concerning the testing by the user are possible via the display 308.

It is understood that the modules 107-108, 206-207, and 306-307 may include computerized code in the form of one or more programs that are stored in the first storage system 102, the second storage system 202, and the third storage system 302. The computerized code includes computer-readable program code (instructions) that are executed by the at least one first processor 106, the at least one second processor 205, and the at least one third processor 305 to provide functions for the modules 107-108, 206-207, and 306-307. The first storage system 102, the second storage system 202, and the third storage system 302 may be a cache or a dedicated memory, such as an EPROM, HDD, or flash memory.

The first communicating unit 101, the second communicating unit 201, and the third communicating unit 301 are configured for building a data-exchange network between the electronic device 100, the environment regulating device 200, and the testing device 300. The first communicating unit 101, the second communicating unit 201, and the third communicating unit 301 may be, but are not limited to, an antenna or a network port.

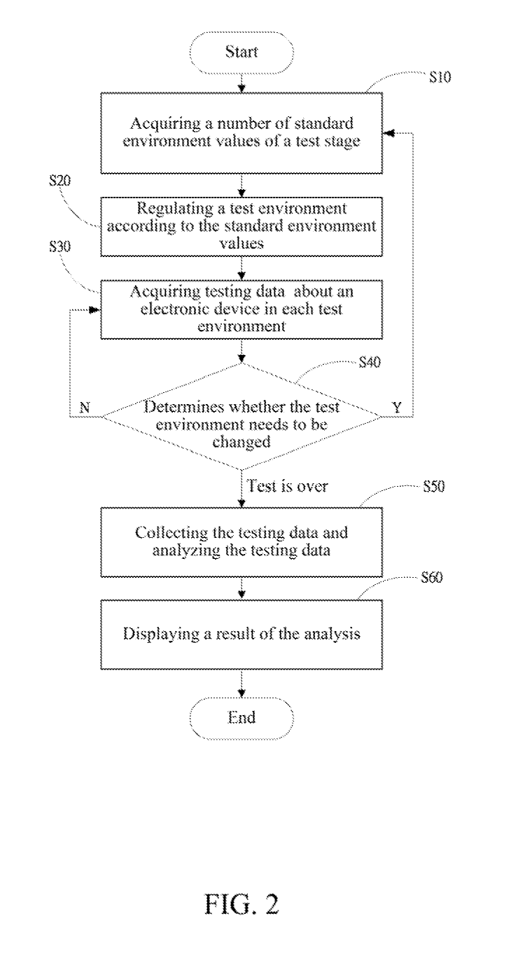

FIG. 2 is a flowchart of one embodiment of a testing method for automatically regulating the test environment and testing the electronic device 100 in different test environments. Depending on the embodiment, additional steps may be added, others deleted, and the ordering of the steps may be changed.

In step S10, the environment regulating device 200 acquires the conditions of the standard environment values of the test stages from the controlling module 107.

In step S20, the environment regulating device 200 regulates the environment in accordance with the standard environment values. In detail, the comparing module 206 compares the test environment values with the relevant standard environment value. The regulating module 207 controls the implementing unit 204 to increase the intensity of the test environment values if the test environment values are less than those of a minimum value in a range applicable to the particular standard environment value. The regulating module 207 controls the implementing unit 204 to decrease the intensity of the test environment values if the actual test environment values are greater than the maximum values a range which is permitted in relation to the particular standard environment values. The regulating module 207 transmits the ready instruction to the testing module 108 and the timer 104 and turn offs the implementing unit 204 when each test environment value falls within a permitted range of the corresponding standard environment value.

In step S30, the testing module 108 starts the first testing unit 105 and the second testing unit 304 to acquiring the testing data about the electronic device 100 when the ready instruction is received.

In step S40, the controlling module 107 determines whether the test environment needs to be changed according to the test stage change instruction from the timer 104. If the timer 104 does not generate the test stage change instruction, the testing module 108 continues to acquire the data from testing the electronic device 100. If the timer 104 generates the test stage change instruction, the controlling module 107 transmits the standard environment values the next test stage to the environment regulating device 200.

In step S50, if the timer 104 generates a finish instruction, the data collecting module 306 collects the data from the first testing unit 105 and the second testing unit 304. The analyzing module 307 analyzes the data from the first testing unit 105 and the second testing unit 304 to generate a result of the analysis.

In step S60, the analyzing module 307 transmits the result(s) of the analysis to the display 308. The result(s) are shown on the display 308 by means of charts, text, or figures.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An electronic device positioned in an environment regulating device, and in electronic communication with the environment regulating device, the electronic device comprising:
a first storage system that stores a plurality of standard environment values corresponding to a plurality of test environments of the environment regulating device;
a first testing unit;
at least one first processor; and
a controlling module operable to control the environment regulating device to regulate the test environments according to the corresponding standard environment values; and
a testing module operable to control the first testing unit to test the electronic device when the test environment is stable.

2. The electronic device of claim 1, wherein the standard environment values comprise a temperature-testing value, a pressure-testing value, and a humidity-adjustable value.

3. The electronic device of claim 1, wherein the environment regulating device comprises:
a second storage system;
an environment measuring unit that measures a plurality of test environment values corresponding to the test environment of the environment regulating device;
an implementing unit;
at least one first processor; and
a comparing module operable that compares the test environment values tested by the environment measuring unit with the standard environment values; and
a regulating module operable that controls the implementing unit to regulate the test environments according to a result of the comparison of the comparing module.

4. The electronic device of claim 3, wherein the regulating module controls the implementing unit to decrease one of the test environment values of the test environment within the environment regulating device when the corresponding test environment value is greater than a maximum value according to a range for the corresponding standard environment value, the regulating module controls the implementing unit to increase one of the test environment values of the test environment within the environment regulating device when the test environment value is below a minimum value according to a range for the corresponding standard environment value.

5. The electronic device of claim 3, wherein when each test environment value of the test environment falls within an allowable range of each corresponding standard environment value, the test environment is stable, the regulating module turns off the implementing unit and generates a ready instruction.

6. The electronic device of claim 5, wherein the electronic device further in electronic communication with a testing device, the testing device comprises:
a third storage system;
a second testing unit being controlled by the testing module to test the electronic device;
at least one third processors; and
a data collecting module operable that collects testing data of the first testing unit and the second testing unit; and
an analyzing module operable that generates an analysis result according to the testing data collected by the data collecting module.

7. The electronic device of claim 6, wherein the testing module controls the first testing unit and the second testing unit to test the electronic device when the testing module receives the ready instruction.

8. The electronic device of claim 6, wherein the electronic device further comprise a timer for timing a duration of each test environment, the timer generates a test stage change instruction when the time of one of the test environment is over, the timer pauses after generating the test stage change instruction, the timer generates a finish instruction when the time of the last test environment is over, the timer stops timing after generating the finish instruction.

9. The electronic device of claim 8, wherein the testing module starts the first testing unit and the second testing unit to test the electronic device when the testing module receives the ready instruction.

10. The electronic device of claim 8, wherein the testing module suspends the first testing unit and the testing device when the testing module receives the test stage change instruction.

11. The electronic device of claim 8, wherein the testing module stops the first testing unit and the testing device when the testing module receives the finish instruction.

12. The electronic device of claim 8, wherein the controlling module transmits the standard environment values of the next test environment to the environment regulating device when the controlling module receives the stage change instruction.

13. The electronic device of claim 6, wherein the second testing unit is configured for testing a plurality of surface conditions of the electronic device.

14. The electronic device of claim 13, wherein the surface conditions of the electronic device comprises temperature, mechanical stress, and resistance.

15. The electronic device of claim 1, wherein the first testing unit is configured for testing a plurality of working conditions of the electronic device.

16. The electronic device of claim 1, wherein the working conditions comprise output power, working current, and working voltage.

17. A testing method being performed by execution of computer readable program code by a process of an electronic device storing a plurality of standard environment values corresponding to a plurality of test environments, the electronic device is positioned in an environment regulating device and in electronic communication with the environment regulating device, the method comprising:
acquiring the standard environment values of one of the test environments;
regulating the test environment according to the standard environment values;
testing the electronic device to acquiring testing data about the electronic device when each test environment value of the test environment falls within an allowable range of each corresponding standard environment value.

18. The method as claimed in claim 17, further comprising:
determining whether the test environment needs to be changed according to a duration of the test environment;
if the test environment needs to be changed, acquiring the standard environment values of a next test environment.

19. The method as claimed in claim 17, further comprising:
determining whether the duration of the last test environment is over;
if the duration of the last test environment is over, collecting the testing data and analyzing the testing data to generate an analysis result.

20. The method as claimed in claim 19, further comprising displaying the analysis result.
